(19) United States
(12) Patent Application Publication
(10) Pub. No.: US 2006/0143469 A1
(43) Pub. Date: Jun. 29, 2006

(54) Method for identification a user, especially for process automation engineering devices

(75) Inventors: Dieter Schmidt, Nesselwang (DE); Holger Seguin, Betzigau (DE); Markus Kilian, Freiburg (DE)

Correspondence Address: BACON & THOMAS, PLLC, 625 SLATERS LANE, FOURTH FLOOR, ALEXANDRIA, VA, 22314, US

(73) Assignee: Endress + Hauser Wetzer Gmbh + Co. KG, Nesselwang (DE)

(21) Appl. No.: 10/536,746

(22) PCT Filed: Nov. 25, 2003
(86) PCT No.: PCT/EP03/13226

§ 371 Date: Feb. 7, 2006

(30) Foreign Application Priority Data
Nov. 27, 2002 (DE) 102 55 517.6

(51) Int. Cl. H04K 1/00

(52) U.S. Cl. 713/186

(57) ABSTRACT

A method for the identification of a user, especially in the case of devices of process automation technology, where at least one person-specific feature of the user is registered with a sensor and compared with stored features. In the case of a match of the registered, person-specific feature with at least one of the stored features, device access is granted.

The invention relates to a method for identification of a user, especially for devices of process automation technology, as defined in the preamble of claim 1.

In process automation technology, field devices are often used, that, in the case of an industrial process flow, measure, as sensors, various process variables, or control, as actuators, controlled variables. Sensors for determining flow rate, fill level, pressure, temperature, etc. are well known.

For registering the corresponding process variables mass, or volume, flow rate, fill height, pressure, temperature, etc., the sensors are arranged in the immediate vicinity of the pertinent process component.

Examples of actuators are controllable valves, which control the flow rate of a liquid or gas in a section of pipeline.

The sensors deliver measured values, which correspond to the current values of the registered process variables. These measured values are forwarded to a control unit, e.g. a PLC (programmable logic controller), a control room or process control system PCS. Besides conventional 4 to 20 mA connections, ever more frequently, data bus systems are being used, where data communication occurs purely digitally.

In addition to sensors and actuators, also recording devices are being used “in the field”. These recording devices visualize, analyze and store the measured values.

As a rule, process control occurs from a control unit, where the measured values of various field devices are evaluated and, on the basis of the evaluation, control signals are produced for the appropriate actuators.

Besides pure, measured-value transmission, field devices can also forward additional information (diagnoses, status, etc.) to the control unit.

The parametering and configuring of the field devices can occur on site at the field device itself or over the data bus. Signal transmission between field device and control unit can occur in analog or digital form. Known standards are HART®, Profibus®, Foundation Fieldbus® or CAN®-Bus. Often, the data bus used in the field is connected with superordinated company networks. Between the individual networks, controllers serve as gateways. Via the company network, especially the process monitoring, as well as the process visualization and engineering are done by means of corresponding computer units.

The security requirements for process automation systems are becoming always stricter; hence, in many enterprises, process control systems are separated from other company networks. This is intended to prevent unauthorized accessing of field devices.

Currently, security efforts for process control systems are concentrating mainly on the network level. For this reason, programs, which allow an access to field devices e.g. for parametering, configuring, etc., are provided with password protection. In such case, the authorizing of the person, who wants to effect the changes, is a necessary step. In the case of field devices of the firm Endress+Hauser®, there is a security protection against unauthorized changing of parameters on the basis of a locking mechanism. The person, who wishes to perform the changes, must enter a code at the field device, before changes in the field device are possible

Disadvantageous with respect to such security codes is that the particular user must know the security code, in order to be able to interact with the corresponding field device.

Since, present day, a person must, as a rule, know, not only at work but also in private life, a multitude of security codes, e.g. pin numbers in the case of banks, passwords for computer access in networks, etc., it is not certain that the code needed at the field device will be available at the appropriate point in time. Sometimes, security codes are provided in writing on notification slips, but this increases the danger that unauthorized individuals will obtain knowledge of the security code.

An object of the invention, therefore, is to provide a method for the identification of a user, especially for devices of process automation technology, which method does not have the above-mentioned disadvantages and yet can be carried out especially easily and at favorable cost.

This object is achieved by the method as defined in claim 1.

An essential idea of the invention is that the person is not identified on the basis of a code, but, instead, on the basis of a person-specific feature of the user. The person-specific feature is registered with an appropriate sensor and compared with stored user features. When the entered, person-specific feature matches one of the stored features, that person has then identified herself correctly. In the case of devices of process automation, this means that the person obtains access to the device and, therefore, can now change parameters and settings in the device.

One possibility is to use the fingerprint of a person as the person-specific feature. Alternatively, an iris image of the eyes can be used as the person-specific feature.

In the case of using a fingerprint as a person-specific feature, there is, however, the danger that the fingerprint of the authorized person might be copied by an unauthorized person. The copying can occur, for instance, by lifting, mechanically or photographically, the fingerprint left on the sensor. In order to assure an increased security, not always the same person-specific feature is asked for, but, instead, a randomly selected feature.

A further increase of the security is achieved by asking for a plurality of randomly selected features.

The features can be stored in a data memory of the device.

In order not to have to store the appropriate features in every device of the process control system, it is provided according to the invention that the features are stored in a central data memory, to which the pertinent device is connected via a data bus.

The invention will now be explained in greater detail on the basis of an example of an embodiment illustrated in the drawing, the figures of which show as follows:

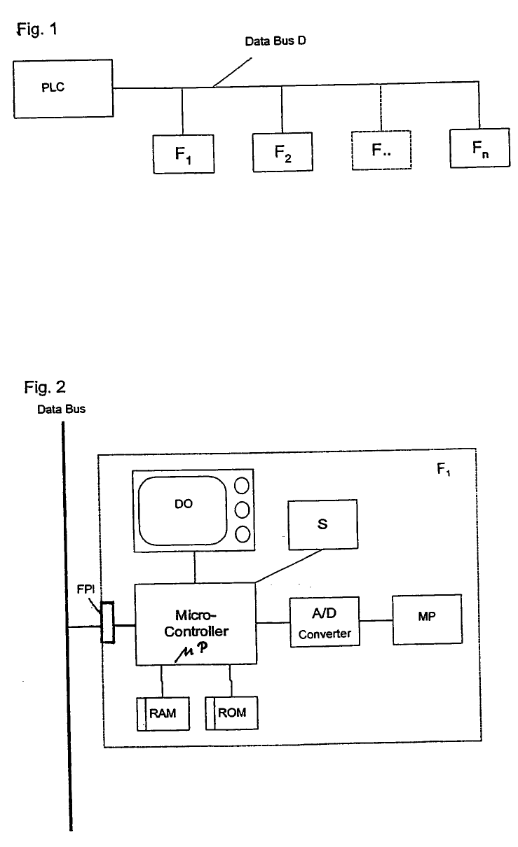

FIG. 1 Schematic illustration of a process control system; and

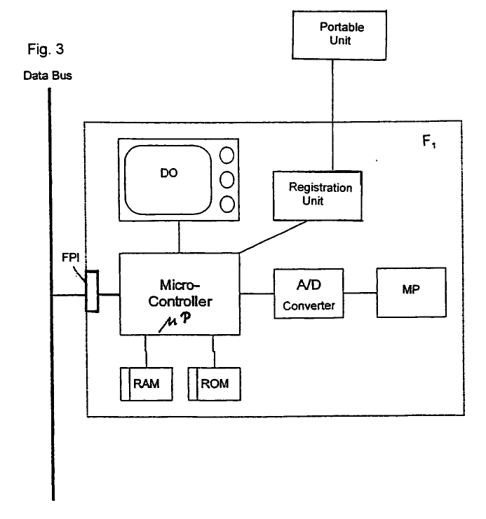

FIG. 2 schematically illustrated block diagram of a device of process automation technology.

FIG. 1 shows a process control system with a programmable logic controller PLC, which is connected via a data bus D with a plurality of field devices F₁, F₂, . . . , Fₙ. The field devices can include actuators, sensors or recording devices. The sensors deliver measured values over the data bus to the control unit PLC, which activates the appropriate actuators.

FIG. 2 shows a block diagram of a device of process automation technology. The device is, for example, a sensor. This field device F₁ has a microprocessor, or microcontroller, μP, which is connected via an analog-digital converter AND with a measurement pickup MP. Serving for operating the field device is a display-operating unit DO, which is likewise connected with the microprocessor μP. Memory is provided in the form of a RAM-memory and an EPROM-memory. Additionally, the microprocessor μP is connected via a field bus interface FPI with the data bus D. Serving for registering the person-specific feature is a fingerprint sensor S, which is likewise connected with the microprocessor μP.

The method of the invention will now be explained in greater detail. Before the user has access to the settings of the device, i.e. before user access is permitted, the user is first prompted to enter a person-specific feature, e.g. middle finger of his left hand. The user must then lay the middle finger of his left hand on the sensor S, which registers this person-specific feature of the user. With an appropriate application program, which runs in the microprocessor μP, this person-specific feature (middle finger, left hand) is compared with stored features. If the registered features match the stored features, then access is granted to the device, i.e. the user can change the parameters of the device F₁ by input via the display-operating unit DO.

If, as person-specific feature, not a fingerprint, but, instead, an iris image is required, then sensor S is a small camera coupled with an appropriate evaluation unit.

In order to prevent unauthorized persons from obtaining access to the device F₁ by lifting the fingerprint of an authorized person, it is provided that the person-specific feature is selected randomly. That is, the application program prompts the user in random manner to enter e.g. the ring finger of the right hand, or the little finger of the left hand, as identification.

Security can be additionally increased by asking for a plurality of person-specific features. The application program prompts the user, therefore, e.g. first to lay the ring finger of the right hand, and then the middle finger of the left hand, on the sensor S. Only with a matching of all features does a granting of user access occur. The person-specific features of the authorized users can either be stored in a memory, e.g. EPROM, in the device F₁, or in a central data memory, which is connected with the device F₁ via the data base D.

Areas of application can be imagined, where a fingerprint sensor S can not be used. This is true especially in areas, where the fingerprint sensor could be exposed at the field device F₁ to strong fouling due to environmental influences. In order also in these areas to be able to meet security requirements for process automation systems, a registration unit is provided, in place of the fingerprint sensor S, for the read-out of user-specific data from a portable unit. The registration unit can be a simple hardware-interface or even a wirelessly working, registration unit. The portable unit is, advantageously, an electronic key, which e.g. is securable on the key ring of the user. This electronic key can be e.g. inserted, in the case where data transfer to the device F₁ is by wire, directly connected with the registration unit. A wireless data transmission is, however, also possible between electronic key and the registration unit. In case necessary, the electronic key can have its own energy supply in the form of a battery or the like. The user identifies herself to the device F₁ by way of the electronic key. For different persons, different electronic keys can be issued, which also permit different user accesses. Thus, separate user rights are possible for startup, certification and servicing. Such electronic keys permit a unique identification of the user to the field device. In this way, user-specific access rights can be assigned. Also in this case, the user then can make use of only the device functionality allowed for such user.

1-10. (canceled)

11. A method for identification of a user, especially in the case of devices of process automation technology, comprising the steps of:
requesting at least one person-specific feature of the user;
registering the person-specific feature with a sensor;
comparing the registered, person-specific feature with stored features; and
granting access to the user upon matching of the registered, person-specific feature with one of the stored features.

12. The method as claimed in claim 11, wherein:
the person-specific feature is a fingerprint.

13. The method as claimed in claim 11, wherein:
the person-specific feature is an iris image.

14. The method as claimed in claim 11, wherein:
the person-specific feature is randomly selected.

15. The method as claimed in claim 11, wherein:
a plurality of person-specific features are requested.

16. The method as claimed in claim 11, wherein;
the stored, person-specific features are stored in a data memory of the device.

17. The method as claimed in claim 11, wherein:
the stored, person-specific features are stored in a central memory, to which the device is connected via a data bus.

18. An apparatus for the identification of a user, especially in the case of devices of process automation technology wherein at least one person-specific feature of the user is requested and compared with stored features, with access being granted when a match results from the comparison, comprising:
at least one sensor:
a programmable logic controller; and
a data bus for connecting said at least one sensor to said programmable logic controller, wherein:
said at least one sensor includes means for registering a person-specific feature of the user.

19. In combination with a device for the identification of a user for process automation technology, an apparatus comprising:
a portable unit containing user-specific data; and
a registration unit at the device, which reads user-specific data from said portable unit.

20. The apparatus as claimed in claim 19, wherein:
said portable unit is an electronic key.
